(19) United States
(12) Patent Application Publication
(10) Pub. No.: US 2006/0195358 A1
(43) Pub. Date: Aug. 31, 2006

(54) Automated coupon distribution system

(76) Inventor: James R. Muldoon, New York, NY (US)

Correspondence Address: KELLY LOWRY & KELLEY, LLP, 6320 CANOGA AVENUE, SUITE 1650, WOODLAND HILLS, CA, 91367, US

(21) Appl. No.: 11/357,723

(22) Filed: Feb. 17, 2006

Related U.S. Application Data
(63) Continuation of application No. 09/612,156, filed on Jul. 7, 2000, now abandoned.
(60) Provisional application No. 60/142,753, filed on Jul. 8, 1999.

(51) Int. Cl. G06Q 30/00

(52) U.S. Cl. 705/14

(57) ABSTRACT

The present invention resides in a process for distributing product entitlements to frequent shopper program members. The process includes communicating with a central retailer server having product purchase histories of frequent shopper program members through a computer network. The frequent shopper program member data, including individual account numbers and related product purchase histories are then captured and copied to a central host system database. A database of available product entitlements is compared to the product purchase history of each member account number. A list of available product entitlements to be associated with each member account number is then selected. Dispensers are provided in the retail store so as to be accessible to the frequent shopper program members. The frequent shopper program member activates the dispenser by entering identifying information related to their specific member account number. Upon activation, the previously selected list of entitlements for the frequent shopper program member account number which has activated the dispenser is communicated to the dispenser. The previously selected list of entitlements are then printed at the dispenser. The entitlements can be printed as coupons or shopping lists. The entitlements are redeemed by matching the entitlements to universal product codes of purchased products scanned at the point-of-sale checkout stand.

### RELATED APPLICATION

This application claims priority from U.S. patent application Ser. No. 09/612,156, filed Jul. 7, 2000, which claims priority from U.S. Provisional Application Ser. No. 60/142,753, filed Jul. 8, 1999.

### BACKGROUND OF THE INVENTION

This invention relates to coupon distribution systems. More particularly, the present invention relates to an in-store coupon distribution system which is intended primarily to target frequent shoppers of the store and conveniently allow the frequent shoppers to obtain and redeem coupons in order to increase customer loyalty to the store or to a particular brand as well as increasing the redemption rate of the coupons.

According to recent surveys, consumer products companies spend over 150 billion dollars annually in the United States on consumer promotion and advertising. Approximately 40% of this expense is directed to advertising of the supermarket industry alone.

Recent reports indicate that approximately 288 billion coupons were distributed in 1999. The bulk of coupons, about 90%, are distributed via free-standing-inserts which are typically four color 8.5 inch by 11 inch glossy inserts that are distributed with the Sunday newspaper. However, it is estimated that over 98% of the free-standing-inserts were discarded resulting less than 2% of these coupons ever being redeemed. A total of 4.6 billion of the 288 billion coupons were actually redeemed. The total value of the redeemed coupons exceeded $3.4 billion. Supermarket or grocery store product distribution totaled 188 billion of the 288 billion coupons (approximately 65%) yet accounted for 77% of the total coupons redeemed.

The current coupon redemption rate is down 3.42% from 1998 and coupon distribution is down 7.5% from 1996. However, in-store and electronically dispensed coupon distribution is up a dramatic 17.2% during this same time period. Thus, major packaged goods companies are looking for innovative ways to heighten redemption levels by better targeting the primary prospective buyers of their brands of goods.

Just as packaged goods manufacturers are trying to build brand loyalty, supermarket retailers continually try to establish a special niche in their marketplace that allows them to stand out from their competition. Two of the major focal points of this niche marketing are the proliferation of store brands and the widespread use of frequent shopper card programs. Both of these efforts are tied into building and maintaining customer loyalty to the supermarket. While the number of store brand items in the supermarket are limited, the frequent shopper card program can encompass all of the approximately 30,000 stock keeping units (or stocked products) sold in the average supermarket. Current industry analysis indicates that 70% of supermarket shoppers are enrolled in a mature frequent shopper program and that 85% of all sales are transacted with a frequent shopper card. More and more supermarket retailers are looking for “value added” enhancements to make their frequent shopper programs more important to their best customers. There are a number of systems currently delivering coupons in-store. One system utilizes in-store machines which are affixed to the shelf directly in front of the item for which the pre-printed coupon is available. The consumer must only take a coupon and purchase the associated product to redeem the coupon. The redemption rate for this system is approximately 17%, nearly nine times higher than conventional free-standing-inserts. However, this system is limited to the number of competing brands to which it can advertise as typically only one brand of product is offered a coupon at any given time. The system is also limited to shelf space. Most importantly, the system does not promote the use of the supermarkets frequent shopper card program and cannot be targeted based on a customer's historical purchasing pattern.

Another system utilizes programmed coupon printers installed at each point of sale check-out cash register. Each customer's purchases are identified by the UPC (Universal Product Code) scanner which reads the item's bar code. In 90% of the transactions, if the system has a competitive coupon available (as opposed to the customer's current purchase), the printer will print a customer coupon for this competing product. The coupons are printed on the system's printer. The coupons are typically valid for approximately four weeks. This system claims a redemption rate of nearly 10%. The coupons generated can be linked to a customer's frequent shopper card, although this is not evident to the customers. However, this system is not convenient as the customer must clip and save the coupon for the next shopping trip. The customer may lose the coupon during this time or may not need to purchase the product category again, for example laundry detergent, before the expiration of the printed coupon.

Yet another system provides interactive terminals near the entrance to the store. Using a touchscreen, the customer follows a series of on-screen commands to select from a multimedia presentation of personalized promotional offers, recipes and the like. The customer can insert their frequent shopping card into the terminal in order to choose coupons from the menu of items available for selection. These coupons must be redeemed during that shopping trip. This system boasts an incredible 35% redemption rate on coupons generated. Although this system promotes both the packaged goods as well as the frequent shopper card program, the process is very expensive. It is estimated to cost $10,000 to $20,000 per interactive terminal. These terminals can also require a significant amount of maintenance due to their complexity. Furthermore, many shoppers are intimidated by the high-tech terminals or are not willing to spend the time to go through the series of screens and options to pro-actively select the coupons every time they go to the store.

Accordingly, there is a need for an in-store coupon distribution system which promotes both the packaged good brand names as well as the supermarket frequent shopper card programs. Such a system should be relatively inexpensive and convenient to the consumer. The present invention fulfills these needs and provides other related advantages.

### SUMMARY OF THE INVENTION

The present invention resides in a process for distributing product entitlements to frequent shopper program members. The process includes communicating with a central retailer server having product purchase histories of frequent shopper program members through a computer network. The frequent shopper program member data, including individual account numbers and related product purchase histories are then captured and copied to a central host system database. The captured data is sorted by individual member account number and the product history of each member account number is categorized into various product categories.

A database of available product entitlements is created and the product purchase history of each member account number is compared to the available product entitlements. A list of available product entitlements to be associated with each member account number is selected based upon the comparison of that account number's purchase history to the available entitlements. The selected list of available product entitlements are then sent to predetermined host system computers at retail stores.

Dispensers are provided within the retail store so as to be accessible to the frequent shopper program members. The frequent shopper program member activates the dispenser by entering identifying information related to their specific member account number. This information can be entered in several ways. At the dispenser, the frequent shopper program member can swipe a card bearing a magnetic strip containing the frequent shopper program member account number. Or a bar code containing the frequent shopper program member account number is scanned at the dispenser. Alternatively, the frequent shopper program member can key in a number associated with the frequent shopper program member account number, which may include the account number itself.

Upon activation, the previously selected list of entitlements for the frequent shopper program member account number which has activated the dispenser is communicated to the dispenser from the host system computer in the retail store. These previously selected list of entitlements are then printed at the dispenser. The entitlements are redeemed by matching the entitlements to universal product codes of purchased products scanned at the point-of-sale checkout stand. Frequent shopper program member transactional data is periodically transferred from the retail store to the retail store's central server.

The invention has two preferred embodiments. In the first preferred embodiment, coupons having product information, rebate information and a bar code are printed at the dispenser. These coupons are used in the traditional manner by scanning the bar code on the coupon and matching this code with a universal product code previously scanned during product purchase at the point-of-sale checkout stand. Where possible the item's in-store location (signified by the aisle number) will also be printed on the coupon. Additionally, coupons will be dispensed in the order in which most people shop the store.

In a second preferred embodiment, a shopping list is printed at the dispenser which includes a list of products and rebate information for each listed product. In another embodiment, the shopping list can include a bar code identifying the frequent shopper program member. The shopping list can also be organized in such a manner that the frequent shopper program member is led through the retail store from the dispenser to the point-of-sale checkout stand in a convenient manner. The aisle number at which the product can be found can also be printed on the shopping list. After the previously selected shopping list is sent to the dispenser, this list is also relayed to a retail store computer in order to allow the matching of, using the universal product codes previously scanned for each purchased product, the shopping list entitlements to products purchased at the point-of-sale checkout during redemption.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic block diagram illustrating the interaction of various components which comprise the system of the invention as they relate to a first paper coupon embodiment thereof;

FIG. 2 is a schematic block diagram illustrating the interaction of various components which comprise the system of the invention as they relate to a second shopping list embodiment thereof; and

FIG. 3 is a flowchart illustrating the several steps taken during the process of the present invention.

### DETAILED DESCRIPTION OF THE PREFERRED EMBODIMENTS

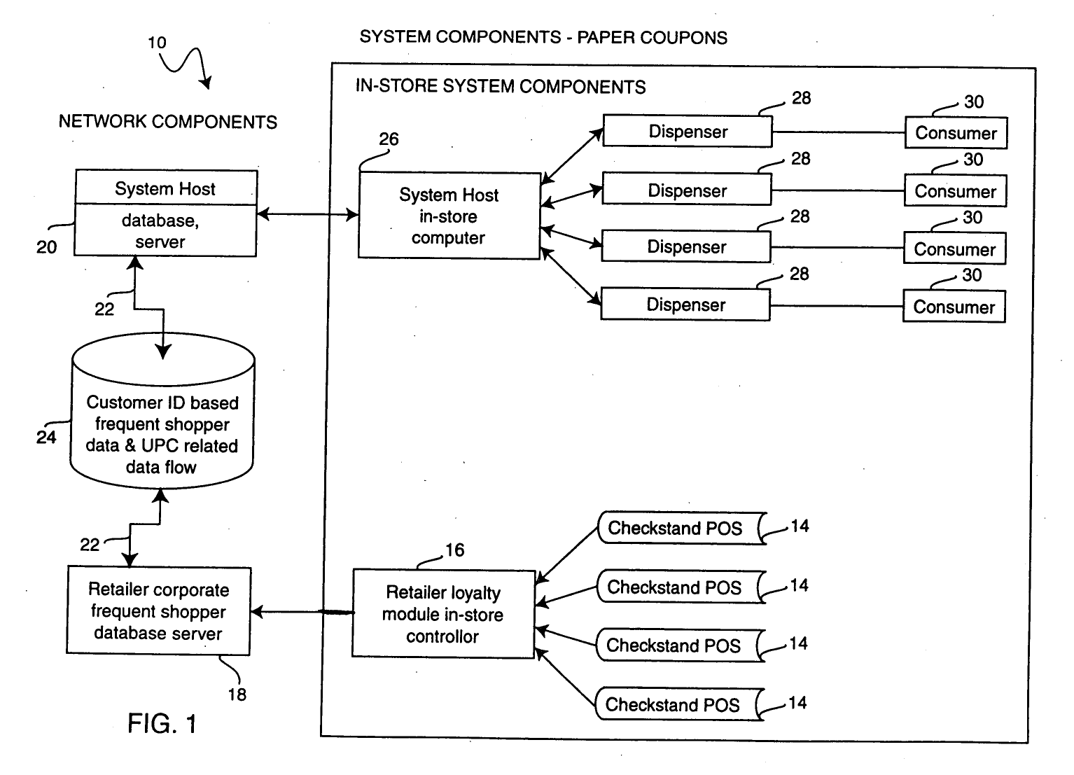

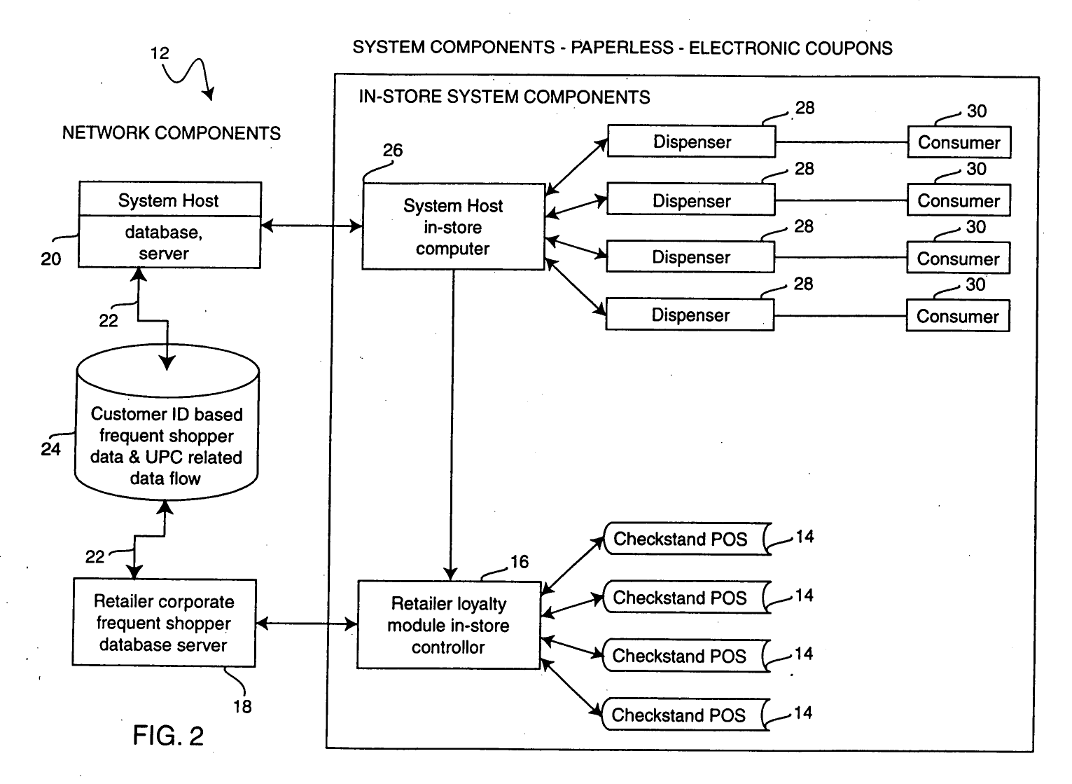

As shown in the drawings for purposes of illustration, the present invention is concerned with a system for distributing product entitlements to frequent shopper program members. A first preferred embodiment of this system is illustrated in FIG. 1 and referenced generally by the reference number 10. A second preferred embodiment of this system is illustrated in FIG. 2 and referred to by the reference number 12. In the drawings, similar components of the systems 10 and 12 have been given the same reference numbers.

Referring to FIG. 1, it is common for retailers who incorporate a frequent shopper program to track and transfer frequent shopper member purchase information, including individual account numbers and related product purchase history detailing each purchase transaction when the frequent shopper program account is used, from the checkstand point-of-sale 14 to an in-store computerized controller module 16. Periodically, the in-store computer 16 transfers the accumulated information to a retailer corporate frequent shopper database server 18. This server 18 accumulates frequent shopper information over time for internal and external use in order to improve the frequent shopper program and increase retailer revenues.

A system host server 20 establishes a two-way communications link 22 with the retailer central server 18 for the capturing and copying of frequent shopper program member data, including individual member account numbers and related universal product code (UPC) product purchase history information 24. The system of the present invention is interested in tracking purchase histories and patterns for each account number, so personal information such as name, address, etc. does not need to be captured. This captured data is sorted by member account number and the product purchase history for each account number is categorized into various categories. These various product categories can include several hundred product categories in which similar products are categorized.

The member account number which now has a corresponding categorized product history, is compared to a database typically maintained by the host system which houses available product entitlements. A list of product entitlements is selected for each member account number. It is then determined which retail store or stores the various frequent shopper program members visit. A copy of the list of product entitlements is then sent to a system host computer 26 having a database and which resides in each retail store.

Therefore a part of the inventive process is the development and use of a proprietary software package that allows the system to command proprietary sorts of frequent shopper data found on the retailer's T-logs (transactional data files). Those proprietary sorts include:

1) Identifying each frequent shopper account number

2) Determining which individual store location(s) that frequent shopper cardholder shops at (historically)

3) Breaking into pre-determined product categories all Stock Keeping Units (SKU's) in retailer's t-log files

4) Sorting to the Universal Product Code (UPC) level all transactions and then fitting each into one of the pre-determined product categories

5) Determining the frequency of purchase by product category (based upon retailer's historical records) by individual frequent shopper cardholder and establishing a “normal” purchase cycle by product category for each frequent shopper account

6) Contrasting each individual frequent shopper account's purchasing cycle against a paradigm developed by analyzing a multitude of such accounts' purchases on a “by product category” basis.

7) Based upon this comparative analysis of purchasing patterns then classifying the individual frequent shopper as having a “heavy”, “normal”, “light” or “non” consumption level of that category.

8) Once this process has been completed on a “by product category” basis it is repeated on a “by brand” basis

It is the development and implementation of this matrix that allows the delivery of the most highly targeted possible entitlements on a customer specific basis

Once the sorting procedure has been completed, the system host corporate database server 20 will have pre-qualified each frequent shopper for their “entitlements” (coupons/discounted offers). Utilizing another part of the proprietary software, the system will match available offers to pre-qualified recipients. The system then employs proprietary algorithm software to match purchaser's cycle history to available promotional offers. Based upon a pre-determined hierarchy, the system prioritizes brand offers to be generated. Once the process has been completed, the appropriate “entitlements” (coupons/offers) are seeded in on a frequent shopper account-specific basis.

In its primary embodiment, the printing/distribution of paper coupons/offers, the host system database server 20 system will pull back the complete file of pre-selected, targeted entitlements on a customer-specific basis.

Once this is completed, it will periodically download these customer-specific entitlement files to the system's in-store database computer 26 where they will remain cached awaiting activation by one of the in-store dispensers 28.

A complete customer-specific entitlement file will be downloaded to every different store location in the retailer's chain where that frequent shopper card account has been used in the prior six months.

Entitlement dispensers 28 are provided in each participating retail store location. The dispensers 28 include a memory device, a communications device, a printer, and means for identifying frequent shopper program members account numbers. Such a means can include a magnetic card reader, a bar code scanner and/or a keypad for the manual insertion of a number identifying the member account number. At least one, and preferably multiple, dispensers 28 are located strategically throughout the retail store. For instance, one or more dispensers 28 can be placed near each entrance. Other dispensers 28 can be placed throughout the store, such as at the bakery, meat department, etc. The dispensers 28 are used to print the previously selected list of entitlements when activated by a frequent shopping program member consumers 30 whose account has been tracked, captured, and a corresponding list previously prepared.

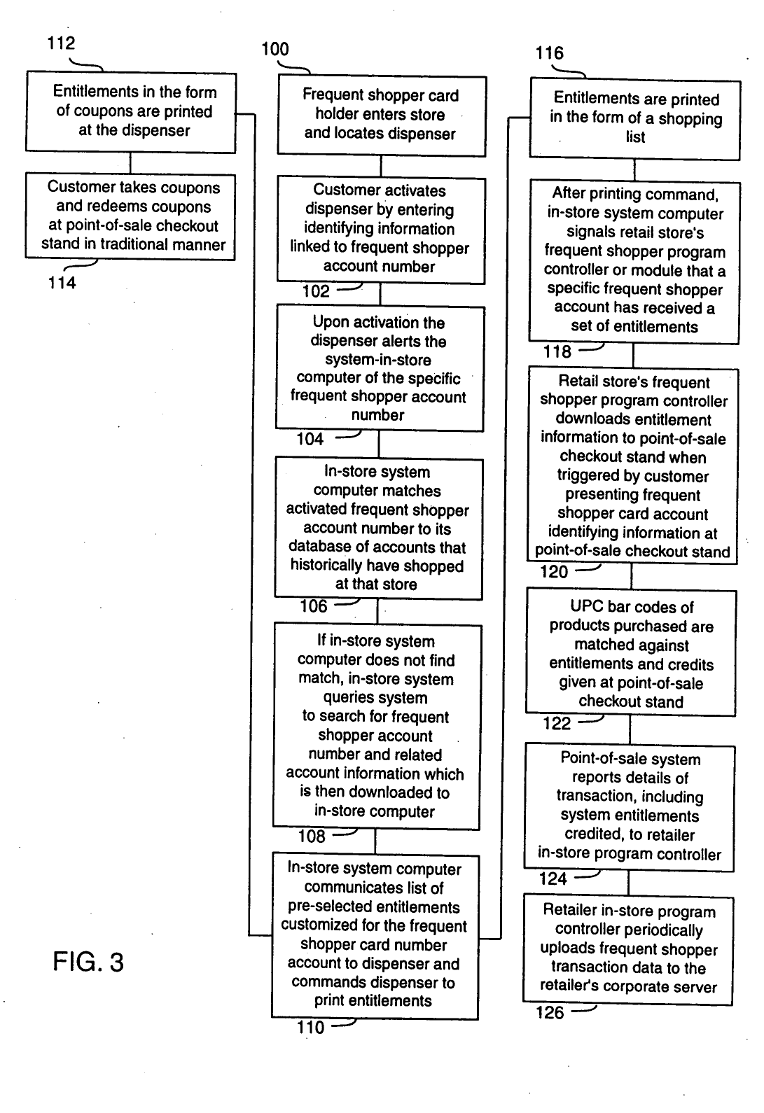

Referring now to FIG. 3, a flowchart illustrates the steps taken during the process of acquiring product entitlements and redemption of the same. The process begins when the frequent shopper card holder enters the store and locates the dispenser 28 (100). The frequent shopper card holder customer activates the dispenser 28 by entering identifying information linked to their particular frequent shopper account number (102). This is done by swiping a magnetic card through a reader, scanning a bar code, or manually keying in a number or code which identifies the member's account number.

Upon activation, the dispenser 28 alerts the system-in-store computer 26 of the specific frequent shopper account number which activated the dispenser 28 (104). The in-store system computer 26 matches the activated frequent shopper account number to its database of accounts that historically have shopped that store (106). If the in-store system computer 26 cannot find a match, it queries host system database 20 to search for frequent shopper account number and related account information which is then downloaded to the in-store computer 26 (108).

The in-store system computer 26 then communicates the list of pre-selected entitlements which are customized for the frequent shopper card number account to the dispenser 28 and commands the dispenser 28 to print entitlements (110). In the first preferred embodiment illustrated in FIG. 1, the entitlements are printed in the form of coupons at the dispenser 28 (112). These coupons mimic standard free-insert coupons in that they include product name, size, rebate offered, and bar code for redemption. The coupon may also include a graphic representation or logo of the product. Preferably, the coupon will be printed on designed paper or include a colored border to prevent fraudulent copying of the coupon. The coupon includes an expiration date which typically extends several weeks or months from printing. The customer takes the printed coupons and redeems those coupons for which the customer has purchased the appropriate product matching the coupon (114). This is done in the standard fashion by scanning the bar code of the coupon after the products' UPC labels have been scanned for purchase. The rebate entitlements are given immediately, similar to standard coupons.

A second preferred embodiment of the present invention is illustrated graphically in FIG. 2. This embodiment is very similar to the first embodiment in that the system host server 20 establishes a two-way communications link 22 with the retailer central server 18 for the capturing and copying of frequent shopper program member data, including individual member account numbers and related universal product code (UPC) product purchase history information 24. Personal information such as name, address, etc. does not need to be captured. This captured data is sorted by member account number and the product purchase history for each account number is categorized into various categories. These various product categories can include several hundred product categories in which similar products are categorized.

The member account number which now has a corresponding categorized product history, is compared to a database typically maintained by the host system which houses available product entitlements. A list of product entitlements is selected for each member account number. It is then determined which retail store or stores the various frequent shopper program members visit. A copy of the list of product entitlements is then sent to a system host computer 26 having a database and which resides in each retail store.

Entitlement dispensers 28 are provided in each participating retail store location. The dispensers 28 include a memory device, a communications device, a printer, and means for identifying frequent shopper program members account numbers. Such a means can include a magnetic card reader, a bar code scanner and/or a keypad for the manual insertion of a number identifying the member account number. At least one, and preferably multiple, dispensers 28 are located strategically throughout the retail store. For instance, one or more dispensers 28 can be placed near each entrance to the retail store. Other dispensers 28 can be placed throughout the store, such as at the bakery, meat department, etc. The dispensers 28 are used to print the previously selected list of entitlements when activated by a frequent shopping program member consumers 30 whose account has been tracked, captured, and a corresponding list previously prepared.

Referring again to FIG. 3, the process begins when the frequent shopper card holder enters the store and locates the dispenser 28 (100). The frequent shopper card holder customer activates the dispenser 28 by entering identifying information linked to their particular frequent shopper account number (102). This is done by swiping a magnetic card through a reader, scanning a bar code, or manually keying in a number or code which identifies the member's account number.

Upon activation, the dispenser 28 alerts the system-in-store computer 26 of the specific frequent shopper account number which activated the dispenser 28 (104). The in-store system computer 26 matches the activated frequent shopper account number to its database of accounts that historically have shopped that store (106). If the in-store system computer 26 cannot find a match, it queries host system database 20 to search for frequent shopper account number and related account information which is then downloaded to the in-store computer 26 (108).

The in-store system computer 26 then communicates the list of pre-selected entitlements which are customized for the frequent shopper card number account to the dispenser 28 and commands the dispenser 28 to print entitlements (110). In this second embodiment, the dispenser 28 prints entitlements in the form of a shopping list (116). The shopping list includes a single sheet of paper listing of products and their brand name and size which are subject to the entitlements and the rebate or entitlement amount for each product. The shopping list may also include a bar code for identifying the customer at the point-of-sale checkstand 14 in certain situations but is typically not needed. Preferably, the shopping list is organized according the order in which the products subject to entitlements will be encountered in the store in order to convenience the customer. For example, if the dispenser 28 is located near an end of the store having a cereal aisle adjacent thereto, a cereal entitlement would appear near the top of the shopping list. If in the same scenario beauty products were to be at the opposite end of the store, a beauty product entitlement would be placed near the bottom of the list. Where possible, the aisle number where the product can be located is printed on the shopping list adjacent the product subject to the entitlement.

It will be necessary that the retailer be provided with an identical set of pre-selected entitlements on a frequent shopper account number and store-specific basis, since it will be the retailer who executes the delivery and crediting of shopping list entitlements at the point-of-sale check stand 14. Therefore the system provides the retailer with the means to accept the identical list of pre-selected entitlements that system host 20 develops and downloads to the system host in-store computer 26 for in-store caching of entitlements awaiting frequent shopper activation at one of the in-store dispensers 28.

This identical list of pre-selected entitlements will reside in the retailer's corporate frequent shopper database server 18. The system further provides the means for the corporate server 18 to download on a store specific basis those entitlements to the retailer's in-store controller 16 where they are cached until such time as the system host in-store computer 26 signals the retailer in-store controller 16 that a specific set of entitlements has been activated by a frequent shopper consumer 30 activating its account at one of the in-store dispensers 28.

After the command to print is sent, the in-store system computer 26 signals the retail store's frequent shopper program controller or module 16 that a specific frequent shopper account number has received a set of entitlements (118). Referring to FIG. 2, it will be noted that there is a one-way communication line from the in-store system computer 26 to the retailer controller module 16 for this purpose.

The retail store's frequent shopper program controller downloads the entitlement information to the point-of-sale checkout stand 14 which that frequent shopper checks out from. The particular checkout stand 14 is known as the frequent shopper member must present his or her account number, usually by presenting their frequent shopper card at the point-of-sale checkout stand (120). As the UPC bar codes of the products purchased are scanned, matches are made against the entitlements which have been downloaded. Credits are immediately given at the point-of-sale checkout stand (122).

The point-of-sale system reports the details of the transaction, including system entitlements credited, to retailer in-store program controller 16 (124). The retail in-store program controller then periodically uploads the frequent shopper transaction data to the retailer's corporate server 18 (126).

Although the present invention has been described as dispensing entitlements for products which are present in the store in which the dispensers 28 are located, it is to be understood that other entitlements in the form of affinity offers and promotions can be offered as well. These affinity offers would be from another retailer, for example a children's clothing retailer, which would be targeted to frequent shoppers who buy baby or children products at the retailer store in which the dispensers 28 are placed. Thus, the customer would receive offers which may be beneficial to him or her, while producing increased shopping at another retailer. Thus, the system could generate an income stream outside of that generated by only grocery entitlements, for example. The present invention can also dispense product advertisements, recipes, retailer “reward” certificates, certificates for “free samples”, rebate forms and other promotional offerings.

The invention is beneficial in many other aspects. A producer of a product, say detergent X, which is not typically purchased by the frequent shopper who typically buys detergent Y can be targeted. Those frequent shoppers who buy baby products or pet products can be targeted. This presents an enormous savings in the form of direct advertising to manufacturers. The likelihood of the customer actually redeeming the coupon also increases dramatically. The retail store can also attract the frequent shopper customer to areas of the store in which he or she typically does not shop, for example the pharmacy. As the entitlements typically have an expiration date normally associated with standard coupons, the customer is not limited to entitlements during that particular shopping trip. As the list of entitlements is previously prepared and selected, only a very short time, typically much less than 20 seconds, is needed to swipe the frequent shopper card and receiving the printed entitlements in the form of coupons or a shopping list. In both embodiments, the customer can be directed to the aisle in which the product is to be found, saving the customer even more time.

Although several embodiments have been described in detail for purposes of illustration, various modifications may be made without departing from the scope and spirit of the invention. Accordingly, the invention is not to be limited, except as by the appended claims.

1. A process for distributing product entitlements to frequent shopper program members, comprising the steps of:
capturing frequent shopper program member data including individual member account numbers and related product purchase histories from a central retailer server using a computer network and transferring the captured data to a central host system database;
comparing the product purchase history of each member account number to a database of available product entitlements;
selecting a list of available product entitlements to be associated with each member account number based on the comparison;
activating a dispenser within the retail store which is accessible to frequent shopper program members by entering information identifying a frequent shopper member account number; and
communicating the previously selected list of entitlements for the frequent shopper member account number which activated the dispenser to dispense and printing the previously selected product entitlements.

2. The process of claim 1, including the step of sorting the captured data by member account number.

3. The process of claim 1, including the step of categorizing the product purchase history of each member account number into various product categories.

4. The process of claim 1, including the step of sending the selected list of entitlements to predetermined host system computers within individual retail stores.

5. The process of claim 1, wherein the printing step includes printing coupons representing the previously selected entitlements.

6. The process of claim 5, wherein the printed coupon includes product information, rebate information and a bar code thereon.

7. The process of claim 6, including the step of redeeming the product entitlements by matching the entitlements to universal product codes of purchased products scanned at a point-of-sale checkout stand.

8. The process of claim 7, wherein the redeeming step includes scanning the bar code on the printed coupon at the point-of-sale checkout.

9. The process of claim 1, wherein the printing step includes printing a shopping list of the previously selected entitlements.

10. The process of claim 9, wherein the shopping list includes a list of products and rebate information for each listed product.

11. The process of claim 10, wherein the printed shopping list is organized in such a manner that the frequent shopper program member is led through the retail store from the dispenser to the point-of-sale checkout in a convenient manner.

12. The process of claim 10, wherein the printed coupons and shopping list includes the aisle number on which each product subject to the list of product entitlements can be found.

13. The process of claim 9, wherein the shopping list includes a bar code which identifies the frequent shopper program member account number.

14. The process of claim 9, including the step of relaying the previously selected list of entitlements sent to the dispenser to a retail store computer in order to allow the matching of the shopping list of entitlements to products purchased at the point-of-sale checkout during redeeming step.

15. The process of claim 14, including the step of relaying the previously selected list of entitlements to the central retailer server.

16. The process of claim 1, including the step of periodically transferring frequent shopper program member transactional data from the retail store computer to the retail store's central server.

17. The process of claim 1, wherein the activating step includes the step of swiping a card bearing a magnetic strip containing the frequent shopper program member account number.

18. The process of claim 1, wherein the activating step includes the step of scanning a bar code containing the frequent shopper program member account number.

19. The process of claim 1, wherein the activating step includes the step of keying in a number which is associated with the frequent shopper program member account number.

20-66. (canceled)
